(19) United States
(12) Patent Application Publication
(10) Pub. No.: US 2013/0276311 A1
(43) Pub. Date: Oct. 24, 2013

(54) Thin Safety Razor

(71) Applicant: Xavier Clemons, Ypsilanti, MI (US)

(72) Inventor: Xavier Clemons, Ypsilanti, MI (US)

(21) Appl. No.: 13/854,166

(22) Filed: Apr. 1, 2013

Related U.S. Application Data
(60) Provisional application No. 61/687,324, filed on Apr. 23, 2012.

(51) Int. Cl. B26B 21/40; B26B 21/06

(52) U.S. Cl. CPC B26B 21/4037; B26B 21/06
USPC 30/50; 30/539

(57) ABSTRACT

A safety razor with a thin profile that can be easily transported on a person, without risk of injury or damage to the razor blades.

### FIELD OF INVENTION

Generally, this invention relates to the class of inventions known as Cutlery. More specifically, this invention belongs to the sub-classes of razors with multiple blades.

### BACKGROUND OF INVENTION

Most men shave some portion of their face every day, or nearly every day. For many men, their beard grows so fast and dense, that they shave more than once per day. Most men with fast-growing and/or thick beards prefer to wet-shave with a safety razor. Wet shaving is using a razor with water and a lubricant, such as shaving cream or soap. A safety razor is a device which has embedded razor blades, to reduce the risk of an inadvertent cut. A safety razor holds one or more razor blades at an angle that will properly shave a beard, while keeping the user's hands a safe distance from the cutting surface. A plurality of men use safety razors to shave.

Most wet-shave safety razors are impractical for a person to carry. Typical safety razors have a head and a handle, forming, roughly, a “T.” Although many safety razors come with a blade protector, the blade protector is generally easy to knock off. Additionally, the shape of the safety razor makes it clumsy to carry in a pocket, purse, or back-pack. When a safety razor is carried in such a way it is easily damaged. Additionally, the blade cover is easily removed through natural jossling and movement, risking injury, or at the very least, a dull and useless blade. Because of these drawbacks, few people carry a safety razor with them during the day.

This creates a difficulty for men who travel and have a thick beard. By the end of the work-day, they would like to shave their beard a second time, but they do not have the means to do so.

Disposable safety razors have additional issues. Disposable safety razors have the same form-factor as a regular safety razor. As a result, they are difficult to vend, because they are relatively bulking and poorly shaped. Additionally, disposable safety razors are relatively expensive to ship, because they do not nest or pack well in a box. Not only does this increase the cost of shipping the disposable safety razor, because the box is full of air, it increases the cost of putting the safety razor on display on a store shelf. Last, disposable safety razors are environmentally unfriendly. They are made out of plastic that is placed in a landfill. Although the metal will bio-degrade, the plastic will not. Additionally, since the metal is embedded in the plastic, the plastic cannot be re-cycled.

The market is looking for a thin, disposable safety razor that can be easily carried by a person during the day. Preferably, such a device should be easy to carry in a safe place, such as a wallet or purse.

### SUMMARY OF THE INVENTION

The present invention improves upon the current prior art, in several important aspects. The present invention is a safety shaver, designed to have a form factor similar to a traditional credit card in width and length. The present invention would be thicker than a traditional credit card, but would have, nonetheless, a very thin profile.

The present invention can have one or more razor blades. The blades are embedded in an integral body. The integral body is made out of hard plastic, including, but not limited to, polylactic acid (PLA) and ABS. In fact PLA would be an ideal material for a disposable safety razor, because the material both bio-degrades and is recyclable into new PLA (cradle-to-cradle recycling). Alternately, the integral body could be made out of other water-proof, hard materials, such as metal. The present invention comes with a firmly fitting cap, to protect the blades.

One embodiment of the invention would have a notch extending around the periphery of the blade head, near where the blades are located. After the blades become dull, such an embodiment would be more environmentally friendly. Using the cap, it would be easy to break the blade head off of the main part of the integral body. As a result, most of the invention, by weight would be recyclable as a single material.

### BRIEF DESCRIPTION OF THE DRAWINGS

FIG. 1 shows a full front view of the first embodiment of the present invention.

FIG. 2 is a full side view of the first embodiment of the present invention.

FIG. 3 shows a full front view of a second embodiment of the present invention.

FIG. 4 is a full side view of a second embodiment of the present invention.

FIG. 5 is a full front view of a third embodiment of the present invention.

FIG. 6 is a full side view of a third embodiment of the present invention.

FIG. 7 is a perspective view of the present invention.

FIG. 8 is a full front view of the cap of the present invention.

FIG. 9 is a side view of the cap of the present invention.

FIG. 10 is a full front view of the present invention with cap.

FIG. 11 is a full front view of a fourth embodiment of the present invention, with cap.

FIG. 12 is a side, see-through view of the present invention.

### DETAILED DESCRIPTION OF THE INVENTION

This description does not limit the invention, but rather illustrates its general principles of operation. Examples are illustrated with the accompanying drawings. A variety of drawings are offered, showing the present invention incorporated into two primary embodiments.

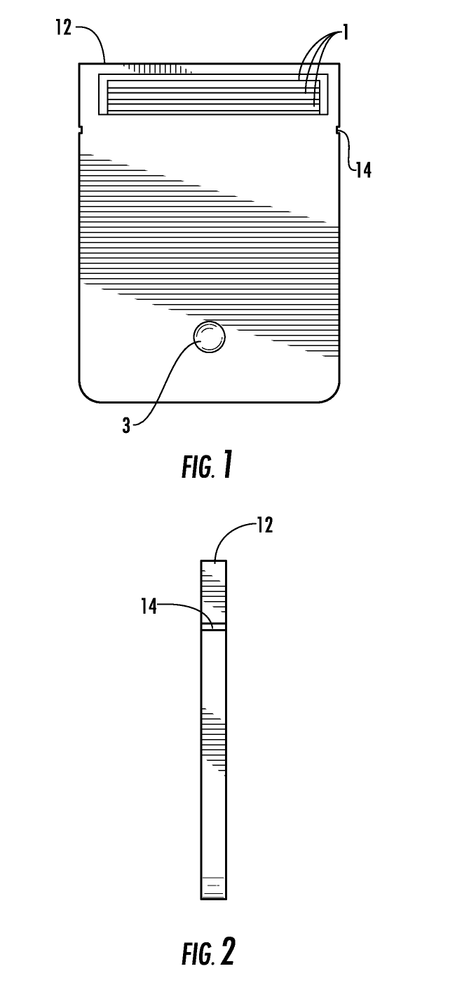

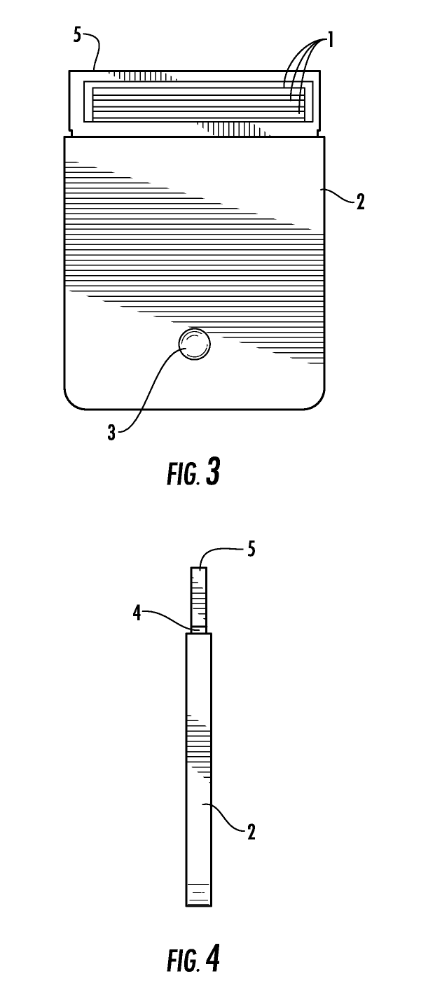

FIG. 1 shows a full front view of the first embodiment of the present invention. The present invention contains a plurality of razor blades 1 embedded in an integral body 12. The razor blades 1 are embedded during fabrication using common molding technics, including, but not limited to, insert injection molding. The razor blades 1 are angled so as to make a suitable cutting angle for shaving a beard. The integral body 12 has a thumb-sized dimple 3, to help the user grip the present invention. The integral body 12 is most commonly produced from plastic, including, but not limited to ABS, Noryl, polycarbonate, and polypropylene. The integral body 12 contains a notch 14 that securely captures the cap of the present invention. FIG. 2 shows a full side view of the present invention, showing that the integral body 12 has a thin profile. FIG. 8 and FIG. 9 show a cap 6 that fits over the blades 1 of the present invention. In the first embodiment, the cap 6 fits proud over the blades 1, meaning the cap 6 sticks out from the integral body 12.

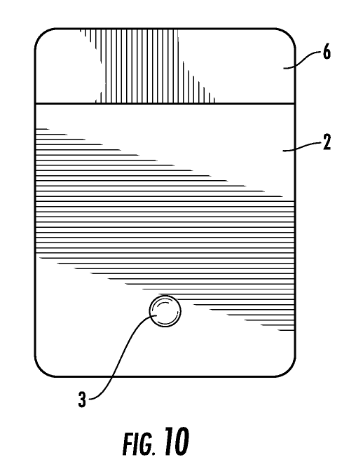

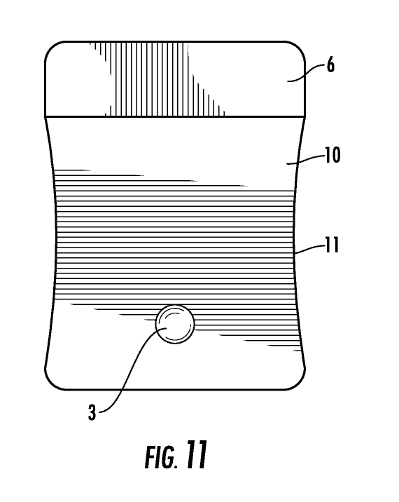

FIG. 3 shows a full front view of the second embodiment of the present invention. This embodiment still contains razor blades 1, that are embedded in an integral body 2, 5 using common molding technics. The integral body is molded so that it has two regions: a blade head 5 and a main body 2. These two regions 5, 2 are molded as a single body. The razor blades 1 are angled so as to make a suitable cutting angle for shaving a beard. The main body 2 has a thumb-sized dimple 3, to help the user grip the present invention. The integral body 5, 2 is most commonly produced from plastic, including, but not limited to ABS, Noryl, polycarbonate, and polypropylene. The integral body 5, 2 contains a notch 4 that securely captures the cap of the present invention. FIG. 4 shows a full side view of the present invention, showing that the integral body 2 has a thin profile. FIG. 8 and FIG. 9 show a cap 6 that fits over the blades 1 of the present invention. In the FIG. 10, the second embodiment has a cap 6 that fits flush, over the blades 1, with the main body 2.

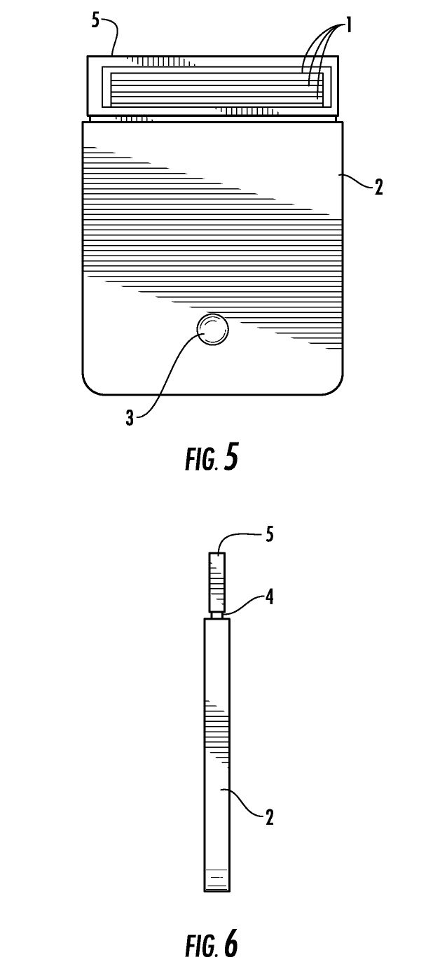

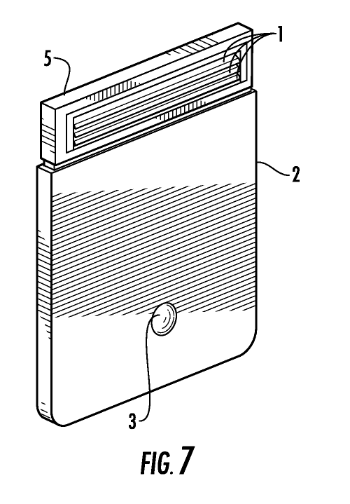

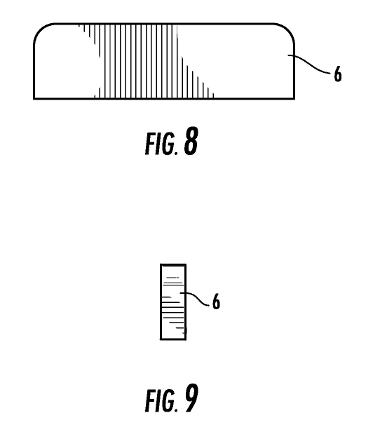

FIG. 5 shows a full front view of the third embodiment of the present invention. This embodiment still contains razor blades 1 that are embedded in an integral body 2, 5 using common molding technics. The integral body is molded so that it has two regions: a blade head 5 and a main body 2. These two regions 5, 2 are molded as a single body. The razor blades 1 are angled so as to make a suitable cutting angle for shaving a beard. The main body 2 has a thumb-sized dimple 3, to help the user grip the present invention. The integral body 5, 2 is most commonly produced from plastic, including, but not limited to ABS, Noryl, polycarbonate, and polypropylene. The integral body 5, 2 contains a notch 4 that securely captures the cap of the present invention. In this embodiment, the notch 4 extends around the entire periphery of the blade head 5. The extended notch 4 more securely captures the cap 6, and allows the blade head 5 to flex with respect to the main body 2. This can present the blades 1 at a better angle to shear a beard. Additionally, the extended notch 4 allows the user to break off the blade head 5, using the cap 6, once the blades 1 become dull and useless. FIG. 4 shows a full side view of the present invention, showing that the integral body 2 has a thin profile. FIG. 8 and FIG. 9 show a cap 6 that fits over the blades 1 of the present invention. In the FIG. 10, the third embodiment, like the second embodiment, has a cap 6 that fits flush, over the blades 1, with the main body 2. FIG. 7 shows a perspective view of the third embodiment, clearly showing the thumb-sized dimple 3, main body 2, blades 1 and the blade head 5. FIG. 12 is a see-through side-view of the third embodiment, showing the blades 1, the main body 2, the blade head 5, the notch 4, and the cap 6. This view shows the spacing and angling of the blades 1, so that they may most effectively cut the beard.

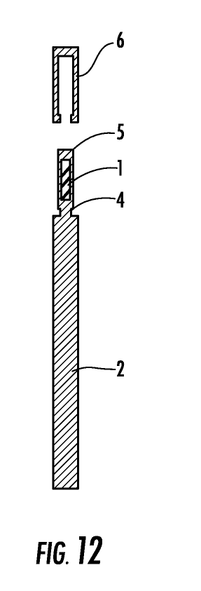

A fourth alternative embodiment is shown in FIG. 11, with the cap 6 on. The major change in this embodiment is that the integral body 10 is contoured 11.

I claim:

1. A safety-shaver, with a thin, flat, form-factor, comprised of at least one razor blade, angled and presented to the user in a way that allows beard hair to be efficiently cut, and embedded in an integral body; a snugly fitting cap, for protecting the razor blades, which securely engages with a notch placed in the integral body to retain the cap; said integral body having a front-side, on which the razor blades are exposed for shaving, that is roughly rectangular with rounded corners; said integral body having a side that expresses its thickness and that has an aspect ratio of less than 1:10 in comparison with the long dimension of the integral body face; and said integral body having a notch for retaining the cap.

2. The invention described in 1, wherein the integral body is made from polylactic acid (PLA).

3. The invention described in 1, wherein the integral body is made from ABS.

4. The invention described in 1, wherein there are three or more razor blades.

5. The invention described in 1, wherein the entire side of the integral body has a substantially similar cross-section, except for the embedded razor blades.

6. The invention described in 7, wherein the cap, when engaged, protrudes beyond the integral body.

7. The invention described in 1, wherein the side of the integral body has two pronounced cross-section, the first said cross-section defining the blade head area, and the second said cross-section defining the main body area.

8. The invention described in 9, wherein the cap, when engaged, is flush with the integral body.

9. The invention described in 1, wherein the side of the integral body has three pronounced cross-sections, the first said cross-section defining the blade head area; the second said cross-section defining the main body area; and the third said cross-section defining a peripheral notch.

10. The invention described in 11, wherein the cap, when engaged, is flush with the integral body.

11. A safety-shaver, with a thin, flat, form-factor, comprised of at least one razor blade, angled and presented to the user in a way that allows beard hair to be efficiently cut, and embedded in an integral body; a snugly fitting cap, for protecting the razor blades, which securely engages with a notch placed in the integral body to retain the cap; said integral body having a front-side, on which the razor blades are exposed for shaving, that has rounded corners, parallel top edge and bottom edge, and two contoured long sides; said integral body having a side that expresses its thickness and that has an aspect ratio of less than 1:10 in comparison with the long dimension of the integral body face; and said integral body having a notch for retaining the cap.

12. The invention described in 11, wherein the integral body is made from polylactic acid (PLA).

13. The invention described in 11, wherein the integral body is made from ABS.

14. The invention described in 11, wherein there are three or more razor blades.

15. The invention described in 11, wherein the entire side of the integral body has a substantially similar cross-section, except for the embedded razor blades.

16. The invention described in 15, wherein the cap, when engaged, protrudes beyond the integral body.

17. The invention described in 11, wherein the side of the integral body has two pronounced cross-section, the first said cross-section defining the blade head area, and the second said cross-section defining the main body area.

18. The invention described in 17, wherein the cap, when engaged, is flush with the integral body.

19. The invention described in 11, wherein the side of the integral body has three pronounced cross-sections, the first said cross-section defining the blade head area; the second said cross-section defining the main body area; and the third said cross-section defining a peripheral notch.

20. The invention described in 19, wherein the cap, when engaged, is flush with the integral body.
